(19) United States
(12) Patent Application Publication
(10) Pub. No.: US 2020/0189438 A1
(43) Pub. Date: Jun. 18, 2020

(54) DEVICE FOR CONTROLLING TILT OF TRUCK CARGO BOX BY USING NAVIGATION SYSTEM

(71) Applicant: NEWKOADWIND., CO. LTD, Gwangju (KR)

(72) Inventor: Minwoo ZANG, Gwangju (KR)

(21) Appl. No.: 16/620,976

(22) PCT Filed: Dec. 4, 2018
(86) PCT No.: PCT/KR2018/015261

§ 371 Date: Dec. 10, 2019

(30) Foreign Application Priority Data
Dec. 13, 2017 (KR) 10-2017-0171243

(51) Int. Cl. B60P 1/28; B60P 1/34; B66F 3/35; B66F 3/46

(52) U.S. Cl. CPC B60P 1/283; B60P 1/34; G01C 21/26; B66F 3/46; B66F 3/35

(57) ABSTRACT

A device for controlling the tilt of a truck cargo box by using a navigation system is described. The device includes: a cargo box tilt control unit installed on the upper side of the chassis of a truck; a cargo box installed on the cargo box tilt control unit; a navigation system for providing information on the current location of the truck, the radius of rotation (curvature) of a road on which the truck is to drive, and the driving speed of the truck; and a control unit for controlling the tilt of the cargo box on a curved driving road by controlling the cargo box tilt control unit on the basis of information provided by the navigation system.

### TECHNICAL FIELD

The present invention relates to a device for controlling the tilt of a truck cargo box using a navigation system,

and more particularly to a device for controlling the tilt of a truck cargo box so as to prevent accidents, such as overturning of the truck having the cargo box loaded with freight on a steep slope way without bearing inertia.

### BACKGROUND ART

In general, a truck (baggage car) transports freight over a long distance while loading the freight in a cargo box thereof.

The cargo box has a structure with an open upper surface thereof, and has a box structure, the inside of which is closed, such as a container box or a wing body.

The truck moves over a long distance while freight is loaded in the cargo box thereof,

the cargo box is fixed to the chassis of the truck, and thus, when the truck runs without deceleration at a sharp curve, overturning of the truck due to inertia of the freight loaded in the cargo box occurs frequently.

This causes damage to the freight and threatens driver safety, and a solution thereto must rapidly be devised.

Conventionally, a system for controlling a conveyance using a gyro sensor and a tilt sensor is disclosed in Korean Patent Registration No. 1007910810000,

and the system is operated through a method using the gyro sensor and the tilt sensor so as to solve problems in loading and unloading of a container box on and from a desired place caused by shaking of a spreader due to strong wind blown from the sea and thus cannot prevent actual overturning of a truck, and is operated only using the gyro sensor and the tilt sensor and thus cannot momentarily reflect an actual driving speed of the truck and a curvature of a road.

### PRIOR ART DOCUMENT

1. Korean Patent Registration No. 1007910810000

### DISCLOSURE

### Technical Problem

Therefore, the present invention has been made in view of the above problems, and it is an object of the present invention to provide

a device for controlling the tilt of a truck cargo box coupled to the chassis of a truck such that the tilt of the cargo box is variable, which controls the tilt of the cargo box using a curvature of a road and speed information provided by a navigation system so as to prevent overturning of the truck on a slope way without bearing inertia.

### Technical Solution

In accordance with the present invention, the above and other objects can be accomplished by the provision of

a device for controlling the tilt of a truck cargo box using a navigation system, the device including a cargo box tilt control unit installed on an upper side of a chassis of a truck, a cargo box installed on the cargo box tilt control unit, a navigation system for providing information on a current position of the truck, a radius of rotation (curvature) of a road on which the truck is to drive, and a driving speed of the truck, and a control unit for controlling a tilt of the cargo box on a curved driving road by controlling the cargo box tilt control unit based on the information provided by the navigation system.

The controller may include

a tilt calculation module configured to calculate the tilt of the cargo box based on the information on the current position of the truck, the radius of rotation (curvature) of the road on which the truck is to drive, and the driving speed of the truck, provided by the navigation system, and a tilt control module configured to drive the cargo box tilt control unit based on result values calculated by the tilt calculation module.

The cargo box tilt control unit may include

an air compressor, a plurality of air bellows operated by high-pressure air supplied by the air compressor, air supply pipes configured to connect the air compressor to the air bellows, and an air distributer provided at the center among the air supply pipes so as to be driven by the control unit and having a plurality of valves.

The cargo box tilt control unit may include

hydraulic jacks, hydraulic jacks configured to the hydraulic jacks, a hydraulic pressure generator configured to provide hydraulic pressure to the hydraulic jacks, pipes configured to transmit the hydraulic pressure generated by the hydraulic pressure generator to the hydraulic jacks, and a hydraulic jack configured to distribute the hydraulic pressure to the respective hydraulic jacks.

A middle portion of a lower end of the cargo box and a middle portion of an upper end of the chassis of the truck may be coupled by a hinge shaft,

and the cargo box may be configured to be rotatable left and right about the hinge shaft.

### Advantageous Effects

The above-described device in accordance with the present invention

receives the information on the current position of the truck, the radius of rotation (curvature) of the road on which the truck is to drive, and the driving speed of the truck, calculates the tilt of the cargo box based on the information, and tilts the cargo box in the opposite direction to a direction in which centrifugal force acts when the truck drives on a curved road, through the cargo box tilt control unit installed on the upper side of the chassis of the truck, and the controller, thereby shifting the center of gravity of freight and thus being capable of effectively minimizing overturning of the truck.

### DESCRIPTION OF DRAWINGS

FIG. 1 is an exploded perspective view of a device for controlling the tilt of a truck cargo box using a navigation system

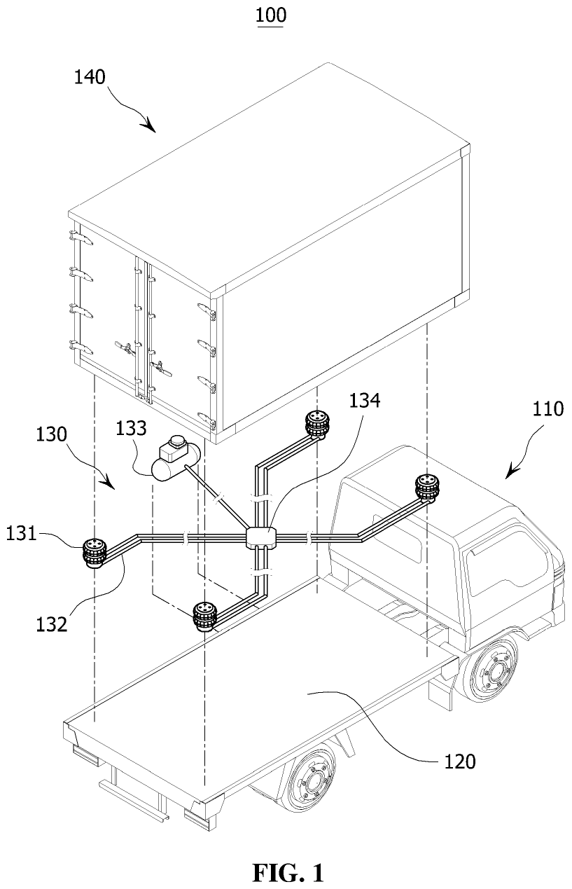

in accordance with one embodiment of the present invention.

FIG. 2 is a side view illustrating an assembled state of FIG. 2.

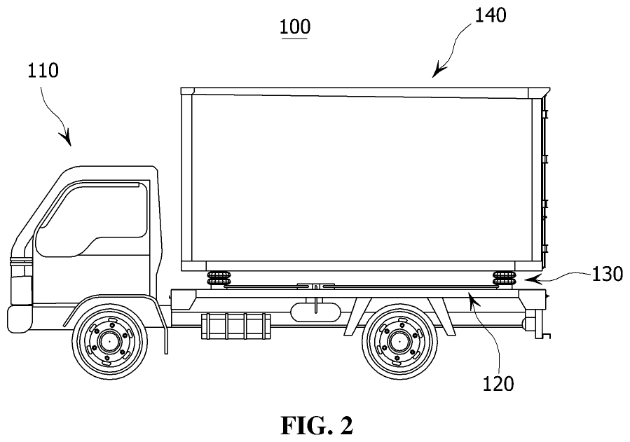

FIG. 3 is a circuit diagram of the device in accordance with the present invention.

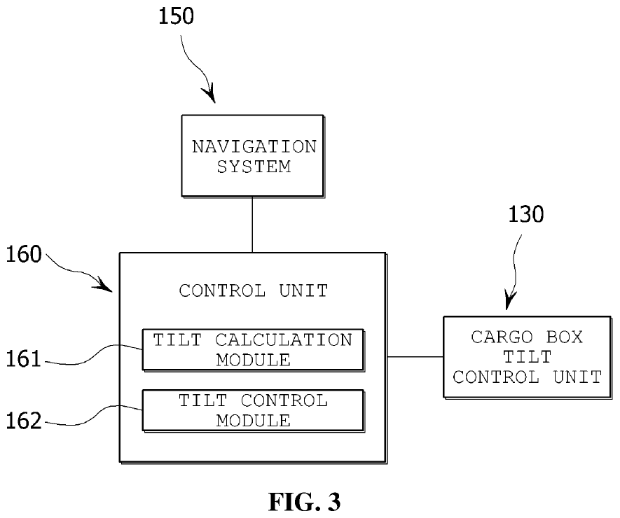

FIG. 4 is a reference view illustrating a use state of the present invention.

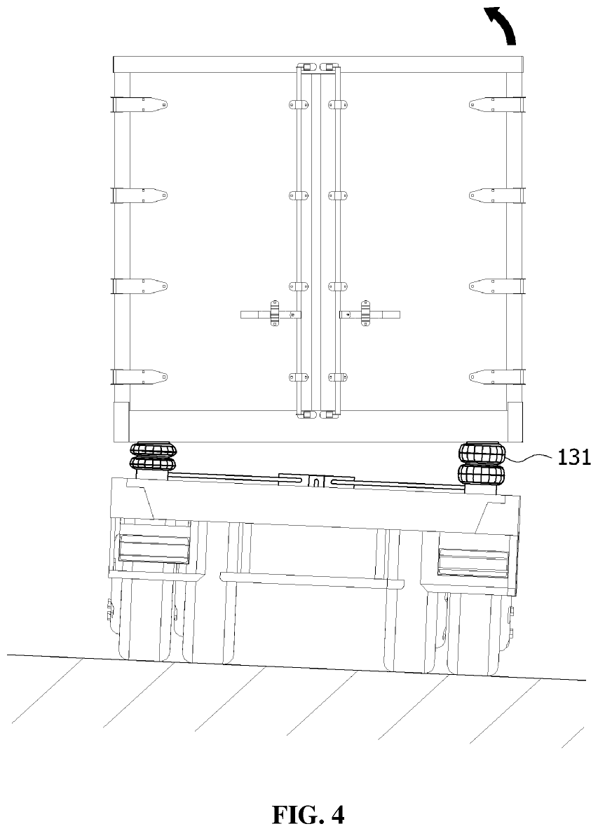

FIG. 5 is a reference view of a device for controlling the tilt of a truck cargo box

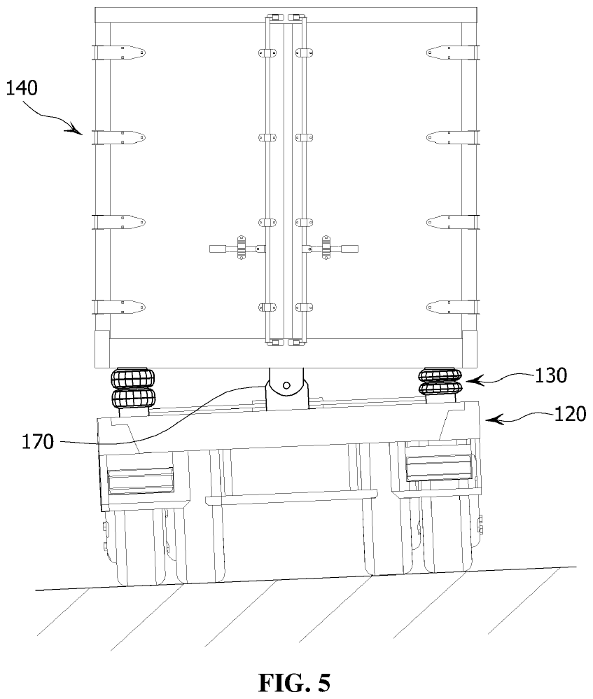

using a navigation system in accordance with another embodiment of the present invention.

FIG. 6 is an exploded perspective view of a device for controlling the tilt of a truck cargo box using a navigation system in accordance with yet another embodiment of the present invention.

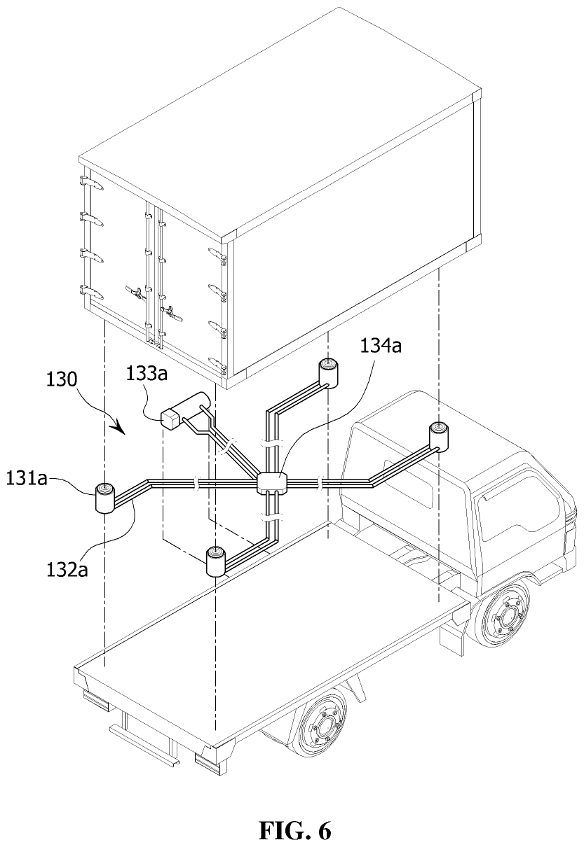

### BEST MODE

Hereinafter, embodiments of the present invention will be described in detail with reference to the accompanying drawings so that those skilled in the art to which the present invention pertains may easily implement the invention.

However, the present invention will be implemented as various different shapes, and is not limited to the embodiments described herein. It will be understood that technical terms used herein serve only to refer to specific embodiments and are not intended to limit the present invention. Further, singular expressions used herein encompass plural expressions, unless they have clearly different contextual meanings. In the following description of embodiments of the present invention, terms, such as “including”, etc., will be interpreted as indicating the presence of specific characteristics, regions, integers, steps, operations, elements and/or components stated in the description, and do not exclude the presence or addition of one or more other specific characteristics, regions, integers, steps, operations, elements, components and/or groups. Even if they are defined differently, all terms used herein, including technical terms and scientific terms, may have the same meaning as generally understood by those skilled in the art. In addition, it will be understood that terms defined in generally used dictionaries have meanings coinciding with related technological documents and contents disclosed herein, and are not interpreted as having ideal or formal meanings unless stated otherwise.

The embodiments of the present invention described with reference to perspective views represent ideal embodiments of the present invention.

Consequently, various modifications in illustrations, for example, modifications of a manufacturing method and/or specification, will be expected. Therefore, the embodiments are not limited to specific shapes in illustrated areas, the illustrated areas in the drawings are only approximate, and the shapes thereof are not intended to illustrate correct shapes of the areas and are not intended to narrow the scope of the invention.

Hereinafter, exemplary embodiments of a device for controlling the tilt of a truck cargo box using a navigation system in accordance with the present invention

will be described in detail with reference to the accompanying drawings.

First, in the drawings, the same or similar elements are denoted by the same reference numerals even though they are depicted in different drawings.

Further, in the following description of the present invention, a detailed description of known functions and configurations incorporated herein will be omitted when it may make the subject matter of the present invention rather unclear.

As shown in the drawings, the device in accordance with the present invention includes

a cargo box tilt control unit 130 installed on the upper side of a chassis 120 of a truck 110, a cargo box 140 installed on the cargo box tilt control unit 130, a navigation system 150 for providing information on the current position of the truck 110, the radius of rotation (curvature) of a road on which the truck is to drive, and the driving speed of the truck, and a control unit 160 for controlling the tilt of the cargo box 140 on a curved driving road by controlling the cargo box tilt control unit 130 based on the information provided by the navigation system 150.

Here, the control unit 160 has

a tilt calculation module 161 to calculate the tilt of the cargo box 140 based on the information on the current position of the truck, the radius of rotation of the road on which the truck is to drive, and the driving speed of the truck, provided by the navigation system 150, and a tilt control module 162 to drive the cargo box tilt control unit 130 based on result values calculated by the tilt calculation module 161.

The navigation system 150 calculates

a driving path and a driving distance from the current position to a destination and provides the calculated driving path and distance to a driver, when destination information is input by a user, and the navigation system 150 has a GPS module so as to receive position information from satellites. In this way, the navigation system 150 transmits GPS information to the control unit 160, and thus, the control unit 160 may detect the current position of the truck.

The tilt calculation module 161 calculates

the optimum tilt of the cargo box 140 corresponding to the current position of the truck in consideration of the curvature of a curved driving road and the driving speed of the truck when the truck drives on the corresponding curved driving road based on the information on the current position of the truck, the radius of rotation of the road on which the truck is to drive, and the driving speed of the truck, provided by the navigation system 150.

The reason for this is to tilt the cargo box 140 in the opposite direction to a direction in which centrifugal force acts, in consideration of the speed of the truck and the radius of rotation of the road,

and thereby, as the center of gravity of the cargo box 140 is shifted closer to the centripetal force direction, the truck becomes more stable. Therefore, accidents, such as overturning of the truck on a slope way without bearing inertia, may be minimized.

The tilt calculation module 161 calculates

the most desirable tilt direction and tilt degree of the cargo box 140 in consideration of the radius of rotation of a curved driving road through which the truck passes currently by analyzing the information on the current position of the truck, the radius of rotation of the road on which the truck is to drive, and the driving speed information of the truck.

The result values calculated by the tilt calculation module 161 are transmitted to the tilt control module 162, and the tilt control module 162 drives the cargo box tilt control unit 130 based on the result values,

thereby being capable of desirably adjusting the tilt direction and tilt degree of the cargo box 140.

The tilt calculation module 161 and the tilt control module 162 are implemented

as program commands which may be executed through various computer units. Although the program commands may be program commands which are specially designed or configured for the sake of the present invention, the program commands may be program commands which are known to those skilled in the field of computer software.

The cargo box tilt control unit 130 may include

an air compressor 133 which is used as an ascending and descending unit, a plurality of air bellows 131 which is operated by high-pressure air supplied by the air compressor 133, air supply pipes 13 which connect the air compressor to the air bellows, and an air distributer 134 which is provided at the center among the air supply pipes so as to be driven by the control unit 160 and has a plurality of valves. Here, solenoid valves may be used as the valves. Further, in the present invention, the cargo box tilt control unit 130 may include known hydraulic jacks 131a, a hydraulic pressure generator 133a to provide hydraulic pressure to the hydraulic jacks, pipes 132 to transmit the hydraulic pressure generated by the hydraulic pressure generator 133a to the hydraulic jacks, and a hydraulic pressure distributor 134a to distribute the hydraulic pressure to the respective hydraulic jacks by valves driven by the control unit 160.

The middle portion of the lower end of the cargo box 140 and the middle portion of the upper end of the chassis 120 may be coupled by a hinge shaft 170,

and the cargo box 140 may be configured to be rotatable left and right about the hinge shaft 170. Here, ascending and descending units are disposed at both sides of the hinge shaft 170. Therefore, the load of the cargo box is distributed to the hinge shaft 170 and the ascending and descending units 131 and 131a, and thus, eccentric concentration of the load on any one side is prevented.

In this way, the present invention tilts the cargo box into an optimum state in the opposite direction to the direction of centrifugal force corresponding to the radius of rotation of a road on which the truck drives,

thereby being capable of preventing the truck from losing balance and thus overturning.

### Mode for Invention

Although the exemplary embodiments of the present invention have been disclosed for illustrative purposes,

those skilled in the art will appreciate that various modifications, additions and substitutions are possible, without departing from the scope and spirit of the invention as disclosed in the accompanying claims.

### INDUSTRIAL APPLICABILITY

The present invention is applicable not only to trucks, but also to vehicles or ships which drive at a high speed.

110: truck

120: chassis

130: cargo box tilt control unit

140: cargo box

150: navigation system

160: control unit

161: tilt calculation module

162: tilt control module

1. A device for controlling a tilt of a truck cargo box using a navigation system, the device configured to have a cargo box tilt control unit installed on an upper side of a chassis of a truck, a cargo box installed on the cargo box tilt control unit, and a control unit for controlling a tilt of the cargo box on a curved driving road, the device comprising:
a navigation system for providing information on a current position of the truck, a radius of rotation (curvature) of a road on which the truck is to drive, and a driving speed of the truck, wherein:
the navigation system provides the information on the current position of the truck, the radius of rotation of the road on which the truck is to drive, and the driving speed of the truck to the control unit having a tilt calculation module (161); and
the tilt calculation module (161) is configured to calculate an optimum tilt of the cargo box (140) corresponding to the current position of the truck in consideration of a curvature of the curved driving road and the driving speed of the truck when the truck drives on the corresponding curved road, and to drive the cargo box tilt control unit so that the cargo box (140) becomes in a most desirable tilt state in consideration of the radius of rotation of the curved driving road through which the truck passes currently.

2. (canceled)

3. The device according to claim 1, wherein the cargo box tilt control unit comprises an air compressor, a plurality of air bellows operated by high-pressure air supplied by the air compressor, air supply pipes configured to connect the air compressor to the air bellows, and an air distributer provided at the center among the air supply pipes so as to be driven by the control unit and having a plurality of valves.

4. The device according to claim 1, wherein the cargo box tilt control unit comprises hydraulic jacks configured to the hydraulic jacks, a hydraulic pressure generator configured to provide hydraulic pressure to the hydraulic jacks, pipes configured to transmit the hydraulic pressure generated by the hydraulic pressure generator to the hydraulic jacks, and a hydraulic jack configured to distribute the hydraulic pressure to the respective hydraulic jacks.

5. The device according to claim 1, wherein a middle portion of a lower end of the cargo box and a middle portion of an upper end of the chassis of the truck are coupled by a hinge shaft, and the cargo box is configured to be rotatable left and right about the hinge shaft.
